(19) United States
(12) Patent Application Publication
(10) Pub. No.: US 2010/0328516 A1
(43) Pub. Date: Dec. 30, 2010

(54) IMAGING APPARATUS

(75) Inventors: Hiroshi Yamashita, Ichinomiya-City (JP); Seigo Yamanaka, Gifu-City (JP)

Correspondence Address: DITTHAVONG MORI & STEINER, P.C., 918 Prince Street, Alexandria, VA, 22314, US

(73) Assignee: SANYO Electric Co., Ltd., Moriguchi-shi (JP)

(21) Appl. No.: 12/879,501

(22) Filed: Sep. 10, 2010

Related U.S. Application Data
(63) Continuation of application No. PCT/JP2009/050844, filed on Jan. 21, 2009.

(30) Foreign Application Priority Data
Mar. 11, 2008 (JP) 2008-061703

(51) Int. Cl. H04N 5/225

(52) U.S. Cl. 348/335; 348/E05.024

(57) ABSTRACT

An imaging apparatus includes a lens actuator which displaces a lens so as to slidingly move along a guide member, and a control circuit which controls the lens actuator. The control circuit supplies a driving signal for vibrating the lens in a second direction opposite to a first direction to the lens actuator before the lens is displaced in the first direction along the guide member.

This application claims priority under 35 U.S.C. Section 119 of Japanese Patent Application No. 2008-061703 filed Mar. 11, 2008, entitled “IMAGING APPARATUS”. The disclosure of the above applications is incorporated herein by reference.

### BACKGROUND OF THE INVENTION

1. Field of the Invention

The present invention relates to an imaging apparatus, in particular, relates to an imaging apparatus which is suitably applied to a camera, a mobile phone equipped with a camera, or the like.

2. Disclosure of Related Art

Conventionally, a lens actuator for driving a lens in the optical axis direction thereof is arranged on an imaging apparatus. The imaging apparatus of such type is mounted on a camera having an auto-focus function, for example. There are various types of configurations in the lens actuator. For example, a configuration in which an electromagnetic driving force generated by a magnet and a coil is utilized to displace the lens can be employed.

In the lens actuator having such configuration, a guide member is arranged in order to smoothly move a holder which holds the lens. If an electromagnetic driving force is applied to the holder, the holder slidingly moves along the guide member.

In the configuration in which the holder slidingly moves along the guide member, there is a risk that a sliding resistance between the holder and the guide member when the lens starts moving form a state where the lens is stopped is increased for various reasons. For example, when the camera is made to be in a non-use state for a long period of time, a contact portion between the holder and the guide member is firmly fixed or the holder does not smoothly slide along the guide member in some case due to dusts, moistures, or the like. Under such state, there arises a risk that the lens cannot be appropriately driven even if a driving force is applied to a lens portion. Further, this causes a risk that auto-focus control or the like cannot be appropriately performed.

### SUMMARY OF THE INVENTION

An imaging apparatus according to an aspect of the invention includes a lens actuator which displaces a lens so as to slidingly move along a guide member and a control circuit which controls the lens actuator. The control circuit supplies a driving signal for vibrating the lens in a first direction and a second direction opposite to the first direction to the lens actuator before the lens is displaced in the first direction along the guide member.

With the imaging apparatus according to the aspect of the invention, the lens vibrates before the lens is displaced. Therefore, even when the guide member and a driven portion at the lens side are firmly fixed or the driven portion does not smoothly slides along the guide member, the failures can be eliminated by the vibration of the lens.

### BRIEF DESCRIPTION OF THE DRAWINGS

The above and other objects and novel characteristics of the invention are made obvious more perfectly by reading the following description of embodiments and the following accompanying drawings.

FIG. 1 is an exploded perspective view illustrating a configuration of a lens driving apparatus according to the embodiment.

FIGS. 2A and 2B are assembly perspective views illustrating a configuration of the lens driving apparatus according to the embodiment.

FIGS. 3A and 3B are views for explaining a driving operation of the lens driving apparatus according to the embodiment.

FIGS. 4A, 4B and 4C are views illustrating a configuration for holding a lens holder according to the embodiment.

FIGS. 5A and 5B are views illustrating a modification of a magnetic plate according to the embodiment.

FIG. 6 is a view illustrating a configuration of an imaging apparatus according to the embodiment.

FIG. 7 is a flowchart for explaining an auto-focus operation according to the embodiment.

FIGS. 8A and 8B are diagrams illustrating a waveform of a current signal output from a driver in the auto-focus operation according to the embodiment.

FIGS. 9A and 9B are flowcharts for explaining a focus searching processing and a focusing processing according to the embodiment.

FIGS. 10A and 10B are graphs illustrating change of contrast values acquired at the time of the focus searching.

FIG. 11 is a flowchart for explaining an auto-focus operation according to a first modification.

FIGS. 12A, 12B and 12C are graphs schematically illustrating change of the contrast values acquired at the time of the focus searching.

FIG. 13 is a flowchart for explaining an auto-focus operation according to a second modification.

FIGS. 14A and 14B are flowcharts for explaining an example in which the auto-focus operation according to the second modification is further modified.

FIG. 15 is a flowchart for explaining an auto-focus operation according to a third modification.

FIG. 16 is a flowchart for explaining an auto-focus operation according to a fourth modification.

FIGS. 17A and 17B are graphs for explaining a relationship between a stop position Ps of the lens holder and a peak position Pp of the contrast value.

FIG. 18 is a flowchart for explaining a focusing processing according to a fifth modification.

FIG. 19 is a diagram illustrating a configuration of a modification of the imaging apparatus according to the embodiment.

FIGS. 20A and 20B are flowcharts for explaining a focus searching processing and a focusing processing according to the imaging apparatus in FIG. 19.

FIG. 21 is an exploded perspective view illustrating a configuration of a modification of the lens driving apparatus according to the embodiment.

FIGS. 22A and 22B are assembly perspective views illustrating a configuration of the lens driving apparatus in FIG. 21.

FIGS. 23A and 23B are views for explaining a normal position and a macro position of the lens driving apparatus according to an embodiment in which the invention is applied to a macro switching function.

FIGS. 24A and 24B are diagrams illustrating a waveform of a current signal for displacing the lens holder between the normal position and the macro position according to an embodiment in which the invention is applied to a macro switching function.

FIG. 25 is a diagram illustrating a modification of a vibration pulse according to the embodiment.

FIGS. 26A, 26B and 26C are diagrams illustrating a modification of the vibration pulse according to the embodiment.

It is to be noted that the drawings are exclusively intended to explain the invention only and are not intended to limit a range of the invention.

### DESCRIPTION OF PREFERRED EMBODIMENTS

Hereinafter, an embodiment of the invention will be described with reference to drawings. An imaging apparatus according to the embodiment includes a lens driving apparatus for auto-focus.

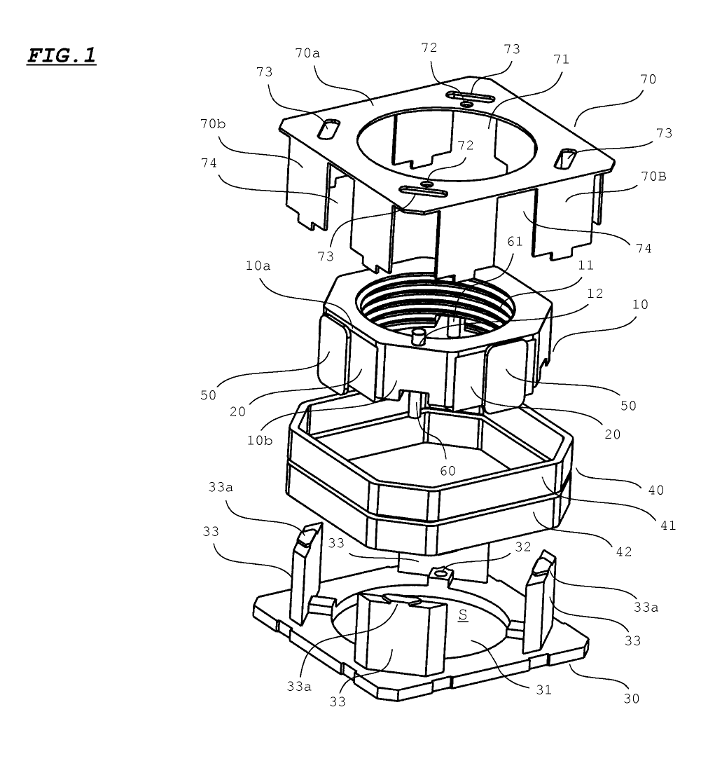

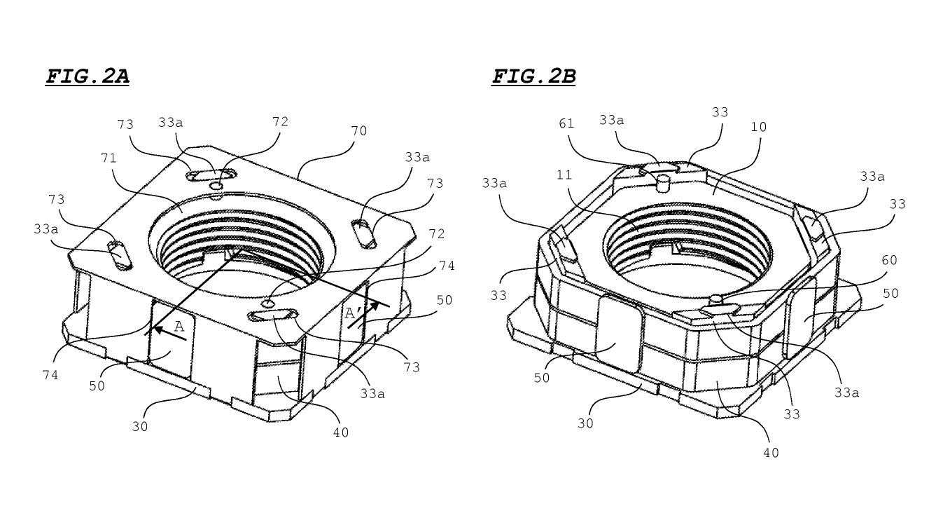

FIG. 1 is an exploded perspective view illustrating the lens driving apparatus. FIGS. 2A and 2B are views illustrating a configuration of the lens driving apparatus after assembled. FIG. 2A is a view illustrating the lens driving apparatus after completely assembled. FIG. 2B is a view illustrating a state where a cover 70 is removed from the lens driving apparatus so as to see an internal state of the lens driving apparatus as shown in FIG. 2A.

A reference numeral 10 indicates a lens holder. The lens holder 10 has an octagon shape in a plan view. A circular opening 11 for accommodating a lens is formed at the center of the lens holder 10. Eight side faces of the lens holder 10 are arranged so as to be symmetric with respect to an optical axis of the lens attached to the opening 11. These eight side faces are composed of four side faces 10a having a large width and four side faces 10b having a small width. The side faces 10a and the side faces 10b are alternately arranged in the lens holder 10.

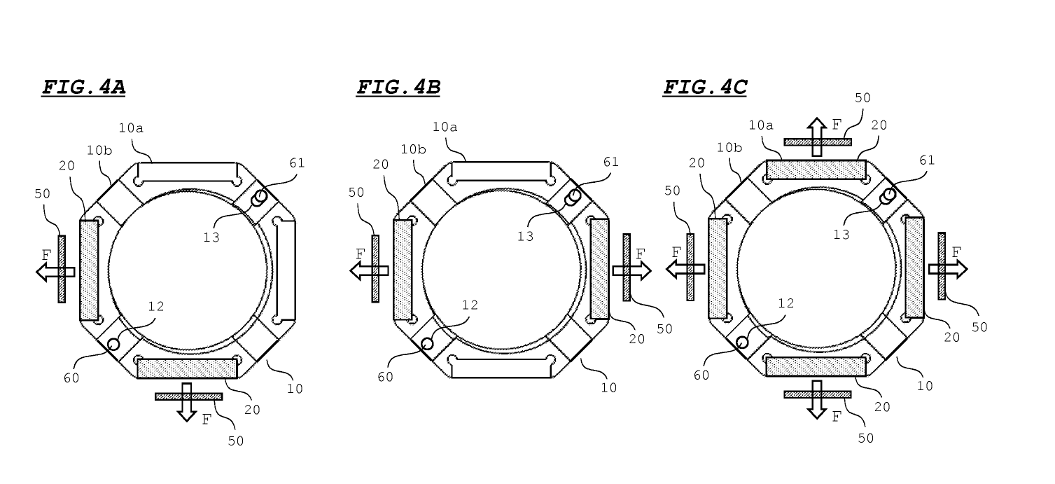

Further, a circular hole 12 and a long hole 13 which engage with two shafts 60, 61 respectively, are formed on the lens holder 10 (see, FIGS. 4A to 4C). A magnet 20 is attached to each of one side face 10a and one side face 10a perpendicular to the above side face 10a among four side faces 10a having a large widths in the lens holder 10. These two magnets 20 have a two-poles arrangement configuration in which an N pole and an S pole are magnetized on side faces. Further, the sizes and the magnetic intensities of the magnets 20 are the same.

A reference numeral 30 indicates a base. The base 30 is formed into a substantially square plate form. An opening 31 for introducing light transmitted through the lens to an image sensor unit is formed on the base 30. Further, two holes 32 to which the shafts 60, 61 are inserted are formed on the base 30. Note that only one hole 32 is illustrated in FIG. 1.

In addition, four guiding members 33 are provided so as to protrude on the periphery of the opening 31. A convex 33a is formed on each of distal ends of these guiding members 33. Note that a space surrounded by these four guiding members 33 corresponds to an accommodating space S of the lens holder 10.

A reference numeral 40 indicates a coil. The coil 40 is winded around an outer circumference of the four guiding members 33. The coil 40 is composed of a first coil 41 and a second coil 42. The first coil 41 and the second coil 42 are connected to each other in series. Winding directions of the first coil 41 and the second coil 42 are opposite to each other. Therefore, current flowing directions in the first coil 41 and the second coil 42 are opposite to each other.

A reference numeral 50 indicates two magnetic plates each of which is made of a magnetic material. These magnetic plates 50 are arranged on an outer circumference of the coil 40 when the lens driving apparatus is assembled. Further, each of the magnetic plates 50 is opposed to each of the two magnets 20 arranged on an inner circumference of the coil 40 across the coil 40.

Reference numerals 60, 61 indicate shafts. Each of these shafts 60, 61 has a circular cross section. The shaft 60 has a diameter which is slightly smaller than an inner diameter of the circular hole 12 formed on the lens holder 10. The shaft 61 has a diameter which is slightly smaller than an inner diameter of the long hole 13 formed on the lens holder 10. It is to be noted that the shafts 60, 61 may be formed with either of a magnetic material or a non-magnetic material.

A reference numeral 70 indicates a cover. The cover 70 is composed of an upper face plate 70a having a substantially square shape and four side face plates 70b hanging from the periphery of the upper face plate 70a. An opening 71 for capturing light into the lens is formed on the upper face plate 70a. Further, two holes 72 to which the shafts 60, 61 are inserted and four long holes 73 to which the convexes 33a of the guiding members 33 are inserted are formed on the upper face plate 70a.

Cutouts 74 are formed on the four side face plates 70b of the cover 70. The cutouts 74 are formed in order to remove the magnetic plates 50 when the cover 70 is covered on the base 30. It is to be noted that each cutout 74 is formed on each of the four side face plates 70b for the following reason. This makes it possible to handle a case where each magnet 20 is arranged on each of all the four side faces 10a of the lens holder 10 and the four magnetic plates 50 are arranged so as to correspond to these respective four magnets 20, as will be described later.

The magnetic plates 50 are attached to the outer circumferential surface of the coil 40 with adhesive or the like and the coil 40 attached with the magnetic plates 50 is arranged on the base 30 when assembled. Next, two shafts 60, 61 are inserted to the circular hole 12 and the long hole 13 of the lens holder 10 so that the lens holder 10 to which the shafts 60, 61 have inserted is accommodated in an accommodation space S of the base from the upper side. At this time, the lower ends of the shafts 60, 61 penetrating through the lens holder 10 are inserted into the holes of the base 30 so as to be firmly fixed. In this state, each of the two magnets 20 is opposed to the coil 40 with a predetermined space. Further, the four side faces 10b of the lens holder 10 are made to be in close contact with the side faces of the guiding members 33. Although not shown in the drawings, the lens is previously attached to the opening 11 of the lens holder 10.

Finally, the cover 70 is attached to the base 30 from the upper side such that the two holes 72 are inserted to the upper ends of the two shafts 60, 61, and four long holes 73 are inserted to the convexes 33a. Accordingly, the lens holder 10 is attached to the base 30 and the cover 70 in a state where the lens holder 10 can be displaced along the shafts 60, 61. Thus, the assembling is completed in a state shown in FIG. 2A.

N poles of the magnets 20 are opposed to the first coil 41 at the upper side and S poles of the magnets 20 are opposed to the second coil 42 at the lower side in the assembled state. Accordingly, when a current signal is applied to the first coil 41 and the second coil 42, the electromagnetic driving force acts on the magnets 20 so that the lens holder 10 slides along the shafts 60, 61.

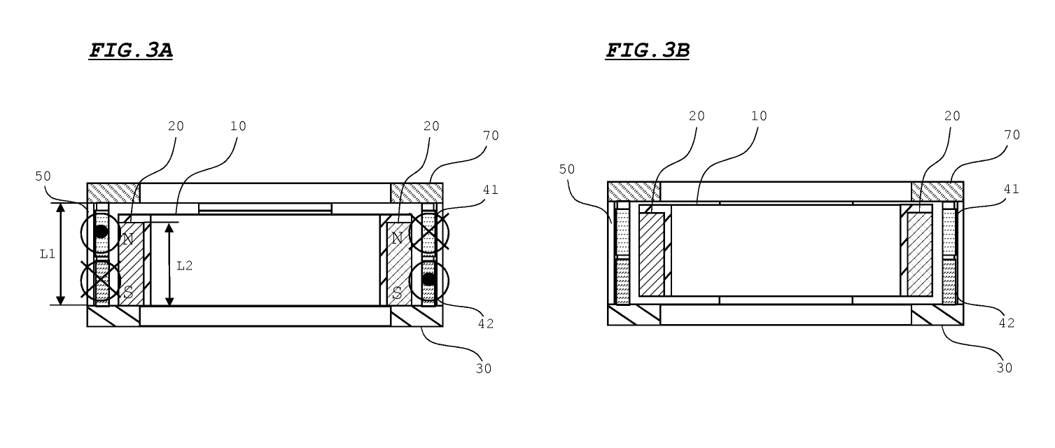

FIGS. 3A and 3B are views for explaining a driving operation of the lens driving apparatus. Note that FIGS. 3A and 3B are cross-sectional views cut along a line A-A′ in FIG. 2A.

FIG. 3A is a view illustrating a state where the lens holder 10 is at a home position. When the lens holder 10 is at the home position, a lower end of the lens holder 10 abuts against the base 30. As described above, magnetized regions of N poles and S poles of the magnets 20 are opposed to the first coil 41 and the second coil 42, respectively. Further, the direction that a current flows in the first coil 41 is opposite to the direction that a current flows in the second coil 42.

If currents are flown in the first coil 41 and the second coil 42 in the directions as shown in FIG. 3A in a state where the lens holder 10 is at the home position, an upward propulsion force acts on the magnets 20. With the upward propulsion force, the lens holder 10 is displaced upward along the shafts 60, 61 from the home position as shown in FIG. 3B. On the other hand, if currents are flown in the first coil 41 and the second coil 42 in the directions opposite to the directions as shown in FIG. 3A from the state as shown in FIG. 3B, a downward propulsion force acts on the magnets 20. With the downward propulsion force, the lens holder 10 is displaced downward along the shafts 60, 61. Note that in FIG. 3A, black circle marks in circles indicate a direction toward an observer of the drawing and cross marks in circles indicate a direction away from the observer of the drawing.

The lens is positioned at an on-focus position while displacing the lens holder 10 upward or downward as described above.

As described above, the home position is set to a position where the lower end (one end) of the lens holder 10 abuts against the base 30. With this configuration, the lens holder 10 can be positioned at the home position by abutting the lens holder 10 against the base 30. Therefore, the lens holder 10 can be appropriately positioned at the home position easily even if the position of the lens holder 10 is not detected.

Now, at the assembled state, the lens holder 10 receives attractive forces F from two directions perpendicular to each other by magnetic forces generated between the two magnets 20 and two magnetic plates 50 opposed to the magnets 20, as shown in FIG. 4A. Further, the lens holder 10 is attracted in the outer circumferential direction with the attractive forces F so that the shaft 60 is pressed against an inner wall of the hole 12 at the side of the holder center. Therefore, a relatively large frictional force is generated between the shaft 60 and the hole 12. Accordingly, when the lens holder 10 is at the on-focus position or the home position, the lens holder 10 is held at the position with the above attractive forces F and frictional force if the current is not supplied to the coil 40.

It is to be noted that as shown in FIG. 4B, a configuration in which the magnets 20 are arranged on the two side faces 10a which are opposed to each other and the magnetic plates 50 are arranged so as to be opposed to the respective magnets 20, in the lens holder 10 can be employed.

With this configuration, the lens holder 10 receives attractive forces F from two directions which are opposite to each other with magnetic forces generated between the magnets 20 and the magnetic plates 50. The lens holder 10 is made to be in a state where the lens holder 10 is hung from the two directions which are opposite to each other with the two attractive forces F. Therefore, even when the lens holder 10 is moved in the vertical direction, the lens holder 10 is hard to be affected with gravity so that driving differences (speed at the time of starting to move, driving response, and the like) between the downward driving time and the upward driving time are hard to be caused. Accordingly, even when the lens driving apparatus is used in a state where the lens holder 10 is moved in the vertical direction, the lens holder 10 can be smoothly driven. Further, when the lens holder 10 is at the on-focus position or the home position, the lens holder 10 is held at the position with the above two attractive forces F even when the current is not supplied to the coil 40.

Further, as shown in FIG. 4C, a configuration in which the magnets 20 are arranged on the four side faces 10a and the magnetic plates 50 are arranged so as to be opposed to the respective magnets 20 maybe employed. With this configuration, the lens holder 10 is made to be in a state where the lens holder 10 is hung from four directions with the attractive forces F more stably. Therefore, the lens holder 10 is less affected with gravity so that the above driving differences are hard to be caused.

As shown in FIG. 3A, the magnetic plates 50 are configured as follows. That is, a length L1 of the magnetic plates 50 in the optical axis direction of the lens is set to be the same as a distance between the base 30 and the cover 70 such that the length L1 is longer than a length L2 of the magnets 20 in the optical axis direction of the lens. Therefore, the attractive forces F generated between the magnets 20 and the magnetic plates 50 can be stably applied to the lens holder 10 in a range (focus adjustment region) where the lens holder 10 is displaced so that the lens holder 10 can be stably held.

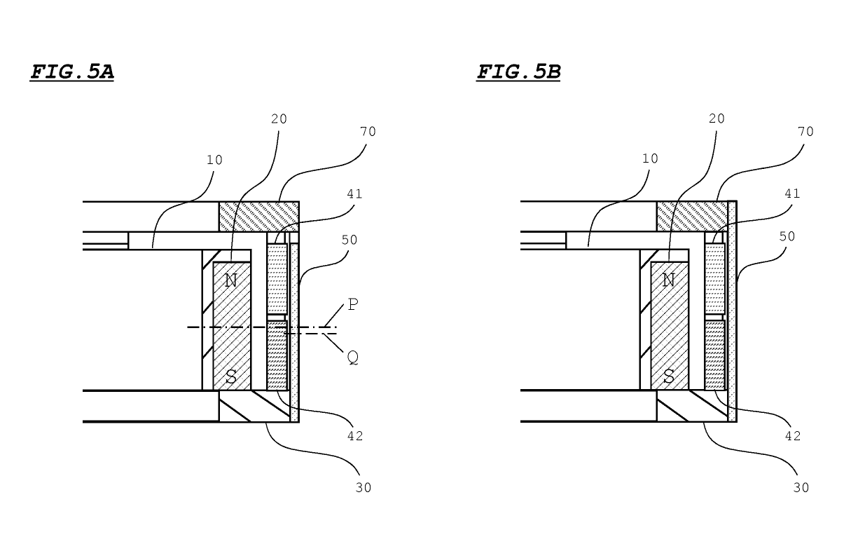

The magnetic plates 50 can be changed to a configuration shown in FIGS. 5A and 5B. In the configuration shown in FIG. 5A, an end of each magnetic plate 50 at the side of the base 30 is extended to an outer bottom surface of the base 30. Therefore, a center Q of each magnetic plate 50 is positioned at the side of the base 30 with respect to a center P of each magnet 20 in a state where the lens holder 10 is at the home position.

When the length L1 of each magnetic plate 50 is not longer than the length L2 of each magnet 20 very much, the magnet 20 is attracted toward the center of the magnetic plate 50. Therefore, in this case, the magnet 20 is attached to the center Q of the magnetic plate 50 so that the lens holder 10 is attracted to the side of the magnetic plate 50 and to the side of the base 30. The lens holder 10 is usually at the home position in many cases, and the lens holder 10 can be stably held at the home position with the above configuration.

In the configuration shown in FIG. 5B, an end of each magnetic plate 50 at the side of the base 30 is extended to the outer bottom surface of the base 30 while an end of each magnetic plate 50 at the side of the cover 70 is extended to an outer top surface of the cover 70. That is to say, the length L1 of each magnetic plate 50 is longer than the length L2 of each magnet 20 as much as possible.

As the difference between the length L1 of each magnetic plate 50 and the length L2 of each magnet 20 is increased in such a manner, a force by which the magnets 20 are attracted toward the centers Q of the magnetic plates 50, that is, an attractive force acting on the optical axis direction (displacement direction) of the lens is decreased. Accordingly, with this configuration, when the lens holder 10 is displaced, the lens holder 10 is hard to be affected by the attractive force in the displacement direction. Therefore, the lens holder 10 can be smoothly driven.

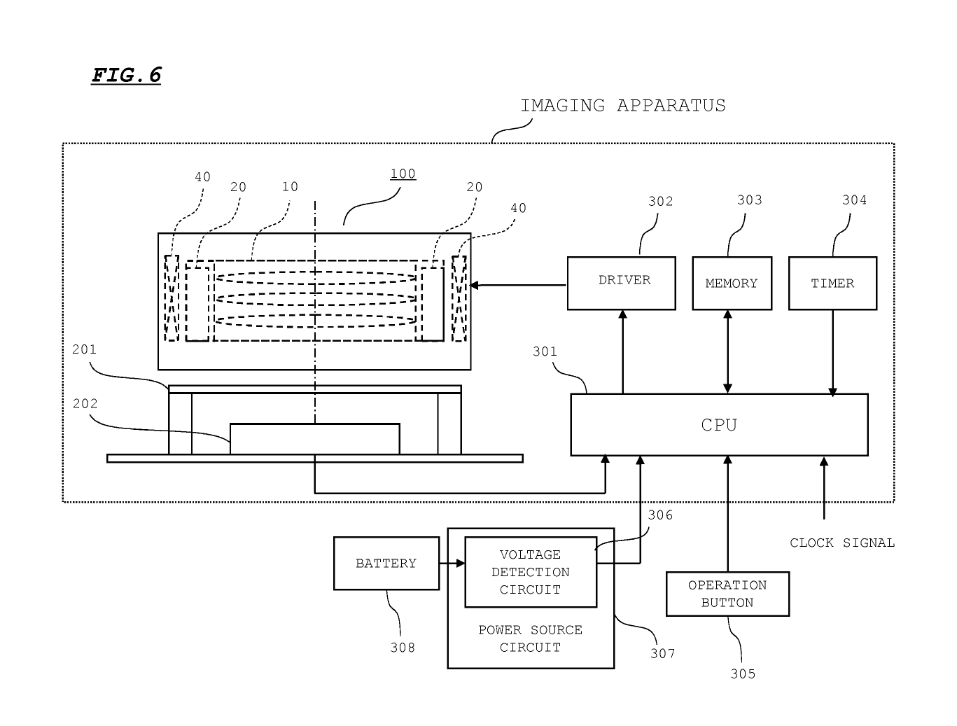

FIG. 6 is a view illustrating a schematic configuration of the imaging apparatus according to the embodiment. The imaging apparatus is mounted on a camera having an auto-focus function, for example.

A filter 201 and an image sensor unit 202 are arranged on a position below the base 30 of a lens driving apparatus 100.

A contrast signal is output to a CPU 301 from the image sensor unit 202. An Image Signal Processor (ISP) is built in the image sensor unit 202. A contrast value of each pixel in an image captured by the image sensor unit 202 is integrated in the ISP. Therefore, an integrated contrast value of the image is calculated so as to be output as a contrast signal. As the lens is focused on a subject more accurately, the image becomes clearer so that the contrast value becomes higher.

A driver 302, a memory 303, a timer 304, an operation button 305 and a voltage detection circuit 306 in addition to the image sensor unit 202 are electrically connected to the CPU 301. The operation button 305 and the voltage detection circuit 306 are arranged in the camera on which the imaging apparatus is mounted.

The memory 303 includes a ROM, a RAM and the like. A control program for operation of the CPU 301 is stored in the ROM. Further, pieces of data such as the contrast value acquired from the image sensor unit 202 are temporarily stored in the RAM. The pieces of data are read from the RAM if necessary.

The timer 304 measures time to notify the CPU 301. The operation button 305 is a shutter button, for example. If the shutter button is half-pressed by a user, a signal directing to adjust focus is output to the CPU 301.

The voltage detection circuit 306 is provided on a power source circuit 307. The voltage detection circuit 306 detects a voltage of a battery 308 to output to the CPU 301. The power source circuit 307 converts the voltage of the battery 308 to a voltage having a size needed for each of other constituents of the imaging apparatus and the camera so as to supply the converted voltage to each of the constituents.

If the CPU 301 receives a direction signal from the operation button 305, the CPU 301 outputs a control signal for auto-focus control to the driver 302. The driver 302 applies a current signal to the coil 40 of the lens driving apparatus 100 in accordance with the control signal from the CPU 301.

The auto-focus operation based on the above configuration is described below.

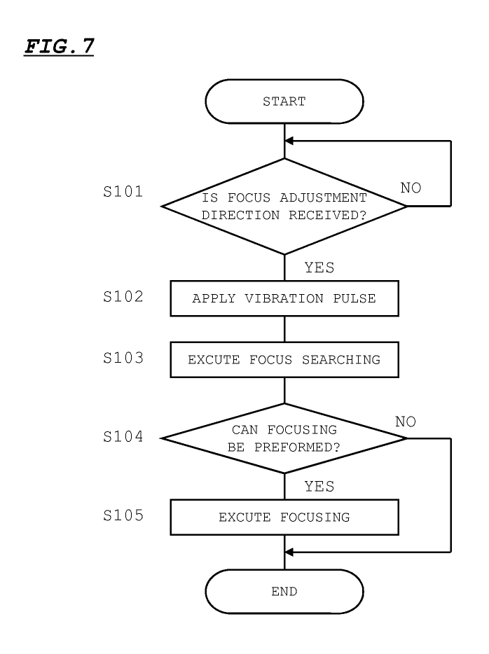

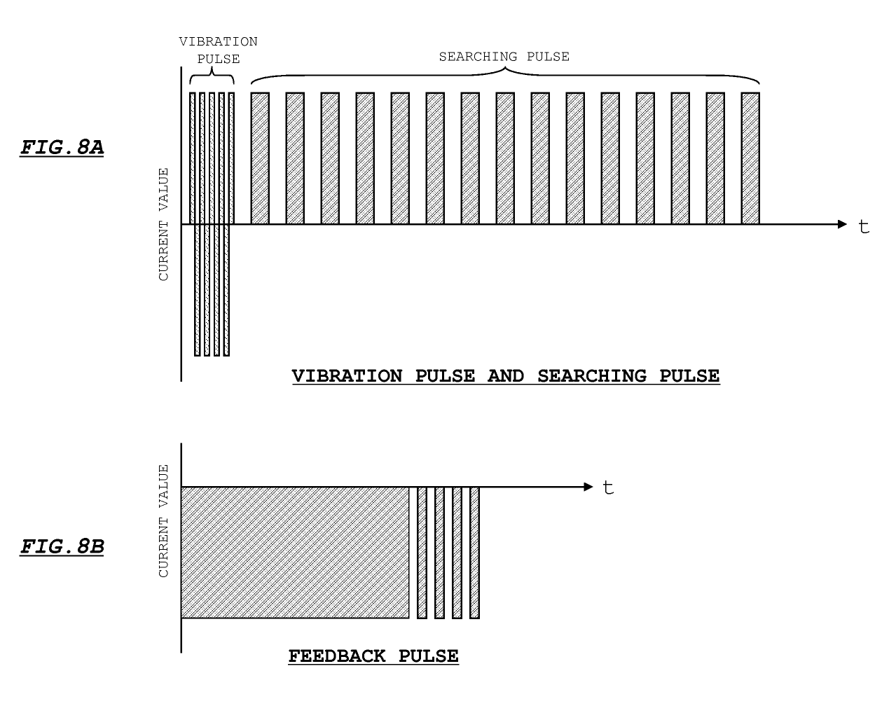

FIG. 7 is a flowchart for explaining the auto-focus operation. FIGS. 8A and 8B are diagrams illustrating a waveform of a current signal output from the driver 302 in the auto-focus operation.

Referring to FIG. 7, if the CPU 301 receives a direction to adjust focus as described above (S101: YES), the CPU 301 controls driving of the driver 302 and applies a current signal (hereinafter, referred to as “vibration pulse”) as shown in FIG. 8A to the coil 40 (S102). As the vibration pulse, a pulsed weak current signal and a current signal having the same shape with a polarity thereof inverted are alternately output for a predetermined number of times. One pulse width of the vibration pulse is set to about several tens μS to about several tens mS, for example. The lens holder 10 weakly vibrates in the optical axis direction of the lens with the vibration pulses while being kept at the home position.

As shown in FIG. 6, a clock signal for generating a current signal is input to the CPU 301. The CPU 301 counts the clock signal with a counter in the CPU 301. The vibration pulse is ON/OFF-controlled in accordance with the counted result. Subsequently, a searching pulse and a feed back pulse which are described later are also ON/OFF-controlled based on the clock signal.

The CPU 301 starts the auto-focus control (optical adjustment control) after the vibration pulse is applied in such a manner. The CPU 301 executes a focus searching processing, at first (S103). The focus searching processing is a processing of acquiring a contrast value while displacing the lens holder 10 in the optical axis direction and detecting an on-focus position based on the acquired contrast value.

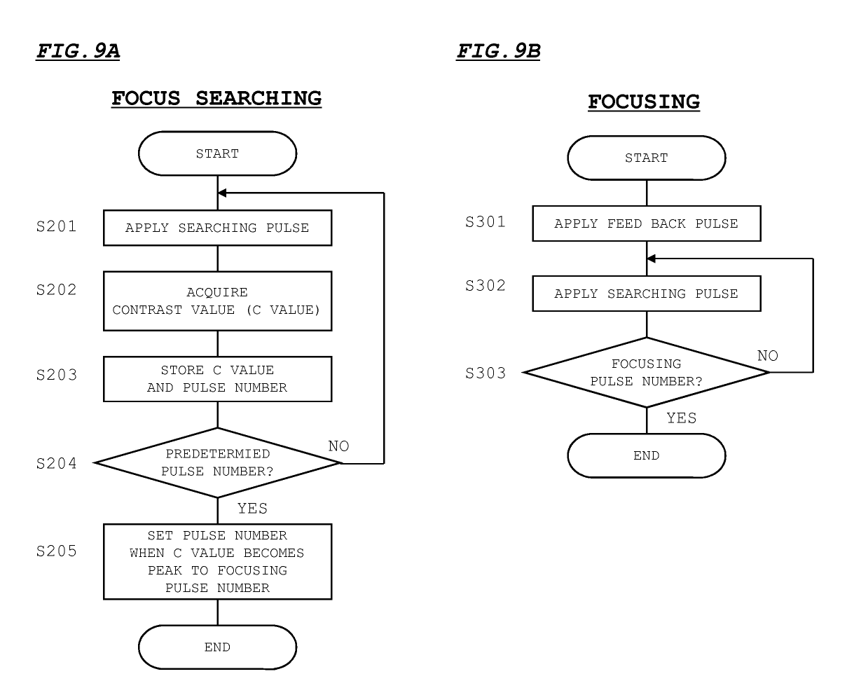

FIG. 9A is a flowchart for explaining the focus searching processing. The CPU 301 applies a pulsed positive current signal (hereinafter, referred to “searching pulse”) as shown in FIG. 8A to the coil 40, at first (S201). The pulse width of the searching pulse is set to about several tens mS to several hundreds mS. The lens holder 10 is gradually (for example, several tens μm per searching pulse) displaced in the optical axis direction of the lens with an electromagnetic driving force generated by the searching pulse. The searching pulse is applied a predetermined number of times (for example, about several tens times). The CPU 301 acquires a contrast value from the image sensor unit 202 every time the searching pulse is applied (S202) and stores the acquired contrast value in the memory 303 in a state where the acquired contrast value is related to the pulse number at that time (S203).

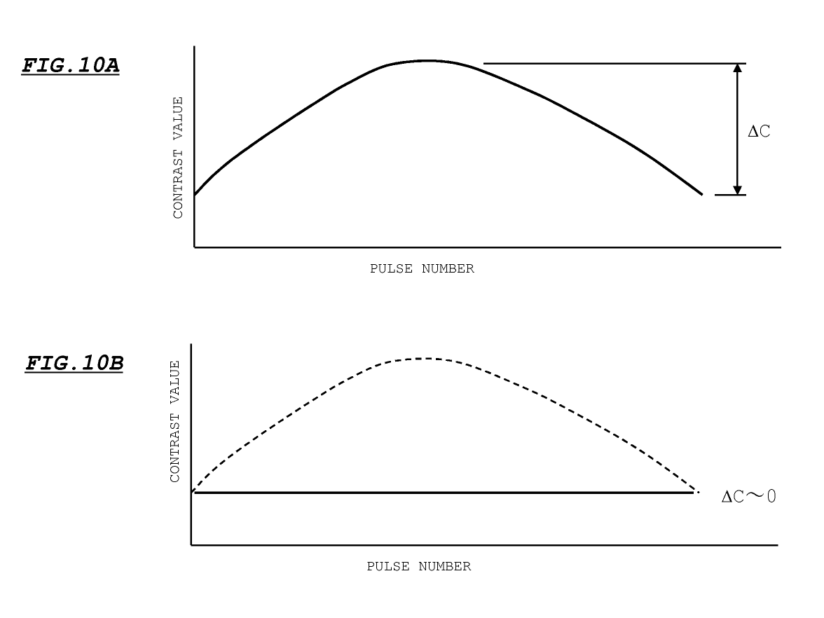

As described above, the contrast value becomes higher as the lens is focused on a subject more accurately. Therefore, when the lens holder 10 is displaced, the contrast value becomes higher as the lens holder 10 is made closer to the on-focus position as shown in FIG. 10A. Then, when the holder 10 reaches to the on-focus position, the contrast value reaches a peak. On the other hand, the contrast value becomes lower as the lens holder 10 is farther from the on-focus position.

If the lens holder 10 is displaced to a terminal position of the focus adjustment region by applying the searching pulse the predetermine number of times (S204: YES), the CPU 301 acquires the pulse number when the contrast value becomes peak from the memory 303. Then, the CPU 301 sets the acquired pulse number to a focusing pulse number for focusing the lens onto the on-focus position (S205).

Returning to FIG. 7, if the on-focus position is detected by the focus searching processing and the CPU 301 judges that the lens can be focused onto the on-focus position (S104: YES), the focusing processing is executed (S105).

FIG. 9B is a flowchart for explaining the focusing processing. The CPU 301 applies a current signal (hereinafter, referred to as “feed back pulse”) including a current signal having long pulse width and a plurality of current signals having short pulse width as shown in FIG. 8B to the coil 40, at first (S301). The feedback pulse displaces the lens holder 10 in the direction opposite to that in the case of the focus searching. Therefore, the polarity of the feed back pulse corresponds to a polarity obtained by inverting that of the searching pulse. With the application of the feed back pulse, the lens holder 10 feeds back to the home position from the terminal position. In this case, the lens holder 10 is displaced to be in the vicinity of the home position by the pulse having long width of the feed back pulse, and then, the lens holder 10 is gradually made closer to the home position by the plurality of pulses having short width of the feed back pulse. Then, the lens holder 10 is positioned at the home position by abutting against the base 30. Since the lens holder 10 softly hits the base 30, the positional deviation due to rebound can be prevent from occurring.

When the lens holder 10 returns to the home position, the CPU 301 applies the searching pulse to the coil 40 again (S302). Then, the searching pulse is applied by the above focusing pulse number of times (S303: YES), the processing is ended. Therefore, the lens holder 10 (lens) is focused onto the on-focus position from the home position.

When the camera is made in a non-use state for a long period of time, there arises a risk that contact portions between the shafts 60, 61 and inner walls of the circular hole 12 and the long hole 13 are firmly fixed due to dusts, moistures, or the like. In this case, the sliding resistance against the lens holder 10 is increased. Therefore, there is a risk that the lens holder 10 does not move even when the searching pulse is applied.

In the embodiment, the vibration pulse as shown in FIG. 8A is applied to the coil 40 and the lens holder 10 vibrates before the lens holder 10 is displaced by the searching pulse. Therefore, event when the contact portions between the shafts 60, 61 and the circular hole 12 and the long hole 13 are firmly fixed, the firm fixing is eliminated with the vibration.

Therefore, according to the embodiment, the lens holder 10 (lens) can be smoothly operated at the time of the auto-focus control so that the auto-focus control can be appropriately performed.

Although the embodiment of the invention has been described hereinabove, the invention is not limited to the embodiment. Further, the embodiment of the invention can be variously modified.

### First Modification of Auto-Focus Operation

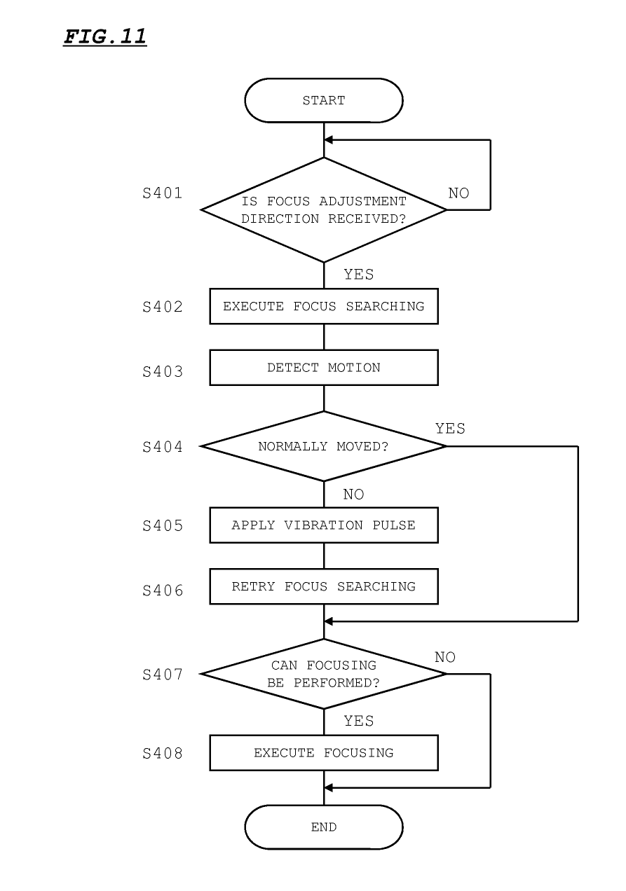

FIG. 11 is a flowchart for explaining an auto-focus operation according to the first modification. Referring to FIG. 11, if the CPU 301 receives a direction to adjust focus (S401: YES), the CPU 301 executes the focus searching processing (S402). Next, the CPU 301 detects motion of the lens holder 10 at the time of the focus searching (S403). Then, the CPU 301 judges whether the lens holder 10 has normally moved (S404).

If the lens holder 10 has normally moved, acquired contrast values change so as to form a mountain-shaped curve having a peak in the middle, as shown in FIG. 10A. Therefore, a difference ΔC between a maximum value and a minimum value of the contrast values appears obviously.

On the other hand, if the lens holder 10 is not moved from the home position due to the above-described firm fixing or the like when the searching pulse is applied, the contrast values keep substantially the same as shown in FIG. 10B and the difference ΔC appears vanishingly.

From the viewpoint, the CPU 301 reads out a maximum value and a minimum value of the contrast values from the memory 303 to calculate a difference ΔC therebetween. Then, the CPU 301 compares the calculated difference ΔC with a predetermined threshold value. If the difference ΔC is larger than the threshold value, the CPU 301 judges that the lens holder 10 has normally moved. In contrast, if the difference ΔC is not larger than the threshold value, the CPU 301 judges that the lens holder 10 does not normally move because the lens holder 10 stops at the home position, for example.

If the CPU 301 judges that the lens holder 10 has normally moved (S404: YES), the CPU 301 judges whether focusing can be performed (an on-focus position is detected) (S407). If the focusing can be performed (S407: YES), the focusing processing as in S105 in FIG. 7 is executed (S408). On the other hand, if the CPU 301 judges that the lens holder 10 does not normally move (S404: NO), it is judged that the auto-focus adjustment cannot be appropriately performed. Then, the CPU 301 applies a vibration pulse to the coil 40 (S405). The firm fixing or the like is eliminated with the vibration pulse so that the CPU 301 executes the focus searching processing again (S406) and restarts the auto-focus control.

With the configuration according to the first modification, if it is detected that the lens holder 10 does not normally move, a vibration pulse is applied. Therefore, firm fixing or the like can be effectively eliminated.

Note that with the following detection method (hereinafter, referred to as “second detection method”), motion of the lens holder 10 can be also detected so as to judge whether the lens holder 10 has normally moved in the first modification.

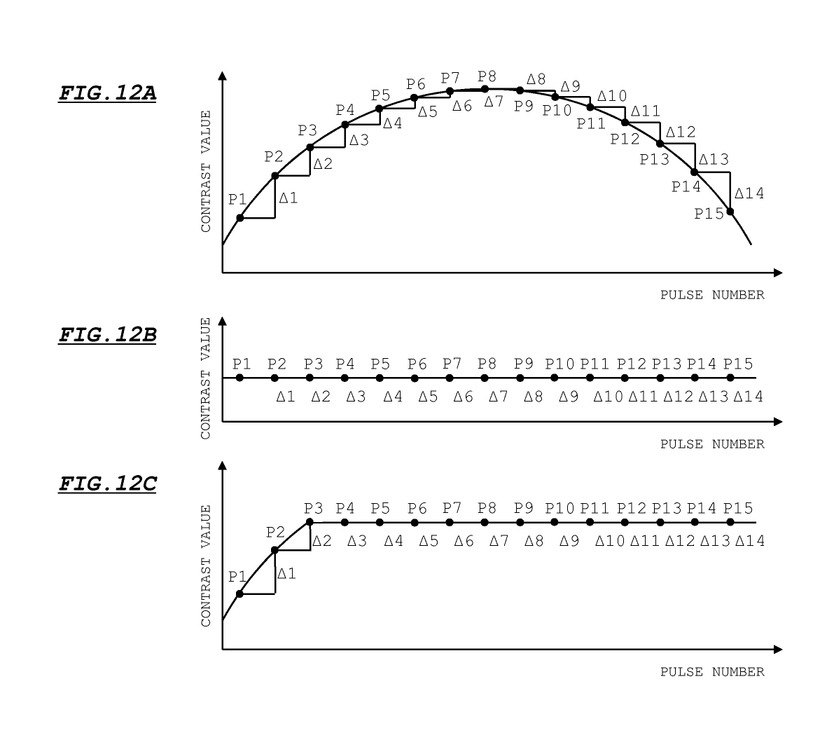

FIGS. 12A, 12B and 12C are graphs schematically illustrating a trajectory drawn by the contrast values at the time of the focus searching. In FIGS. 12A, 12B and 12C, a horizontal axis indicates the number of times that the searching pulse is applied. In this case, the searching pulse is applied fifteenth times and fifteen contrast values (P1 to P15) are obtained. In the second detection method, the differences Δn (Δ1 to Δ14 in examples of FIGS. 12A, 12B and 12) of the contrast values adjacent to each other are calculated.

When the lens holder 10 has normally moved, the differences Δn become values close to zero as the contrast value approaches to the peak value. However, the differences Δn becomes values close to zero in only periods near the peak value. Therefore, the differences Δn does not keep values close to zero for a long period of time.

On the other hand, when the lens holder 10 does not move from the home position, the differences Δn are kept to be values close to zero from the start as shown in FIG. 12B. In other words, when the lens holder does not normally move, the differences Δn continuously indicate values close to zero for a long period of time.

In this case, the CPU 301 can judge whether the lens holder 10 has appropriately moved by detecting a period where the differences Δn indicate values close to zero. That is to say, the CPU 301 compares the differences Δn with the threshold value and if a state where the difference Δn is smaller than the threshold value continues beyond a predetermined number of times (number of times by which it can be judged that the state is not due to the peak), the CPU 301 judges that the lens holder 10 does not normally move.

### Second Modification of Auto-Focus Operation

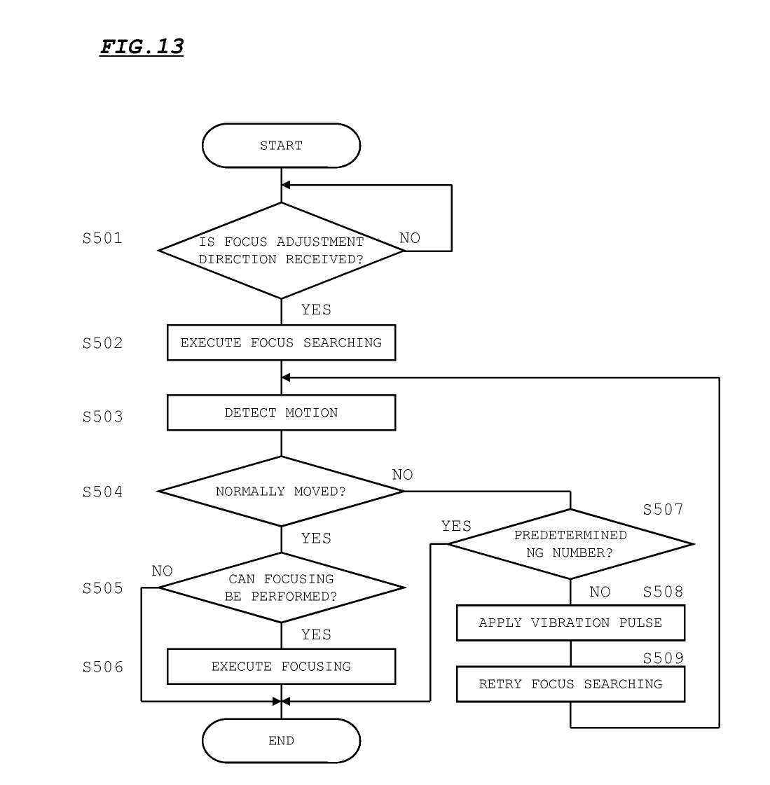

FIG. 13 is a flowchart for explaining an auto-focus operation according to the second modification. Referring to FIG. 13, if the CPU 301 receives a direction to adjust focus (S501: YES), the CPU 301 executes the focus searching processing shown in FIG. 9A (S502). Next, the CPU 301 detects motion of the lens holder 10 at the time of the focus searching (S503) to judge whether the lens holder 10 has normally moved (S504).

If the CPU 301 judges that the lens holder 10 has normally moved (S504: YES), the CPU 301 judges whether focusing can be performed (S505). If the focusing can be performed (S505: YES), the focusing processing is executed (S506).

On the other hand, if the CPU 301 judges that the lens holder 10 does not normally move (S504: NO), the CPU 301 judges whether the number of times that the lens holder 10 is not judged to normally move reaches to a predetermined NG number (for example, about three times) (S507). Then, if the number of times that the les holder 10 is not judged to normally move does not reach to the predetermined NG number (S507: NO), the CPU 301 applies a vibration pulse to the coil 40 (S508). Further, the CPU 301 applies the feed back pulse for returning the lens holder 10 to the home position, and then, executes the focus searching processing again (S509).

Then, the CPU 301 detects motion of the lens holder 10 again (S503) and judges whether the lens holder 10 has normally moved (S504). Since firm fixing or the like is eliminated, it is usually judged that the lens holder 10 has normally moved and a process proceeds to step S505.

However, if the lens holder 10 does not normally move for some reasons such as significant firm fixing and it is judged that the lens holder 10 does not normally move in step S504, the process proceeds to step S507. In such a manner, operations of the application of the vibration pulse and the focus searching are repeated until it is judged that the lens holder 10 has normally moved in step S504 or the number of times that the les holder 10 is not judged to normally move reaches to the predetermined NG number in step S507 (S508, S509). With this configuration, the firm fixing can be eliminated even if the firm fixing is significant.

It is to be noted that if the CPU 301 judges that the number of times that the les holder 10 is not judged to normally move reaches to the predetermined NG number in step 507 in a state where the lens holder 10 does not normally move (S507: YES), the focusing processing is not executed and the auto-focus control is ended.

With the configuration according to the second modification, even in a state where firm fixing or the like cannot be completely eliminated by one application of the vibration pulse, the firm fixing or the like can be eliminated by applying vibration pulses for a plurality of times. Therefore, the lens holder 10 (lens) can be driven more smoothly.

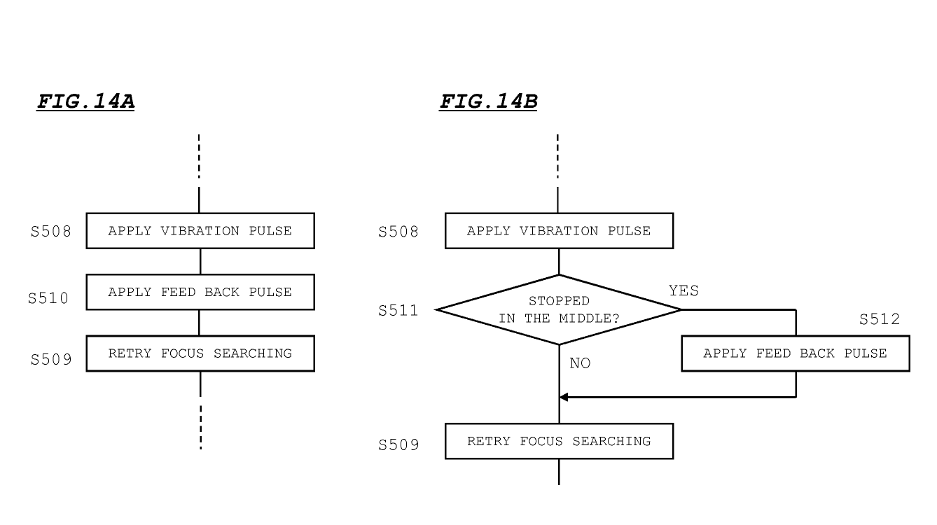

The configuration according to the second modification can be changed to a configuration as shown in FIGS. 14A and 14B. That is to say, after the vibration pulse is applied in step S508, the feed back pulse is applied (S510) in the configuration in FIG. 14A. This is because it is supposable that the lens holder 10 does not move at a position far from the home position when foreign matters adhere to some portions of the shafts 60, 61. In such a case, the lens holder 10 can be once fed back to the home position by applying the feed back pulse. It is to be noted that when the feed back pulse is applied, even if the lens holder 10 is at the home position, the lens holder 10 is only pressed against the base 30 temporarily, thereby causing no trouble.

Further, in the configuration as shown in FIG. 14B, it is judged whether the lens holder 10 has stopped in the middle (S511) after the vibration pulse is applied in step S508. If it is judged that the lens holder 10 has stopped in the middle (S511: YES), a feed back pulse is applied (S512). In this case, a position where the lens holder 10 has stopped can be detected by using the above second detection method. To be more specific, if the lens holder 10 has stopped in the middle, the differences Δn after the lens holder 10 has stopped are substantially zero, as shown in FIG. 12C. Therefore, a position where the lens holder 10 has stopped can be detected by detecting a point at which the difference Δn is substantially zero for the first time. Therefore, it can be judged whether the lens holder 10 has stopped at a position far from the home position 10.

As described above, according to the configuration as shown in FIGS. 14A and 14B, when the lens holder 10 stop in the middle, the auto-focus control can be restarted from the home position. This makes it possible to prevent accuracy of the auto-focus control from deteriorating.

It is to be noted that the auto-focus operation according to the embodiment can be incorporated into the auto-focus operations of the above first modification and second modification. In such cases, an operation in which a vibration pulse is applied (operation in step S102 in the above embodiment) is added before the operation of the step S402 in the first modification and the operation of the step S502 in the second modification.

### Third Modification of Auto-Focus Operation

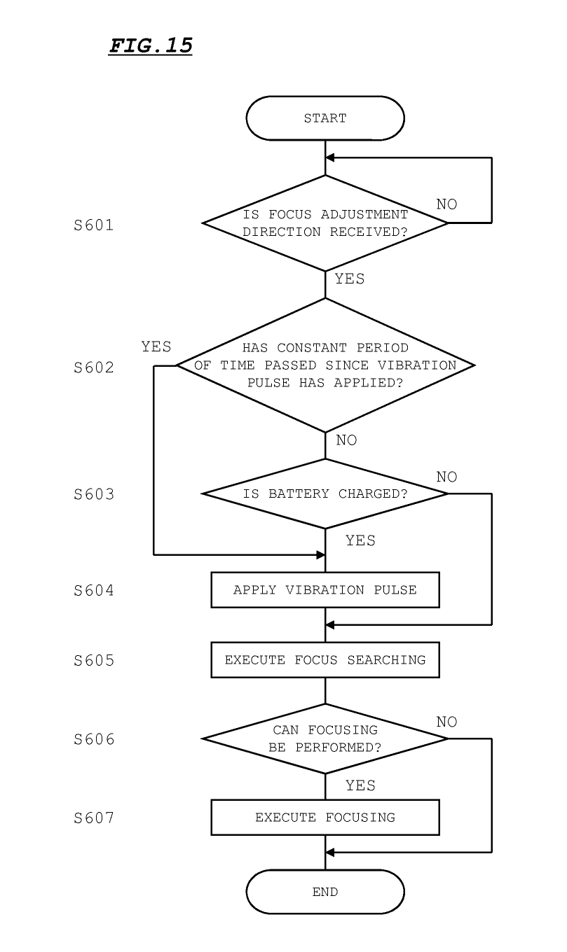

FIG. 15 is a flowchart for explaining an auto-focus operation according to the third modification. Referring to FIG. 15, if the CPU 301 receives a direction to adjust focus (S601: YES), the CPU 301 judges whether a constant period of time has passed since a previous vibration pulse has applied based on time measured by the timer 304 (S602). If the constant period of time has not passed, the CPU 301 judges whether the battery 308 has been charged (exchanged) (S603). When the voltage of the battery 308 detected by the voltage detection circuit 306 is recovered to a voltage fully charged, the CPU 301 can judge that the battery 308 has been charged or exchanged.

When the CPU 301 judges that the above constant period of time has passed (S602: YES) or the battery has been charged (exchanged) (S603: YES), the CPU 301 applies a vibration pulse to the coil 40 (S604). After the application of the vibration pulse, the focus searching processing and the focusing processing are executed as in the above embodiment (S605 through S607).

On the other hand, if the CPU 301 judges that the above constant period of time has not passed (S602: NO) and the battery has not charged (exchanged) (S603: NO), the focus searching processing and the focusing processing are executed (S605 through S607) without applying the vibration pulse.

It is considered that a failure in the lens operation, which is caused by dusts or the like, is not easily occurred for a while if the dusts or the like are once removed by the vibration with the vibration pulse. Then, in the configuration according to the third modification, a vibration pulse is applied at a timing where the lens holder 10 becomes a state of being easily affected by dusts or the like again. Therefore, time and power consumption needed for application of the vibration pulse can be reduced in comparison with those in a case where the vibration pulse is constantly applied.

### Fourth Modification of Auto-Focus Operation

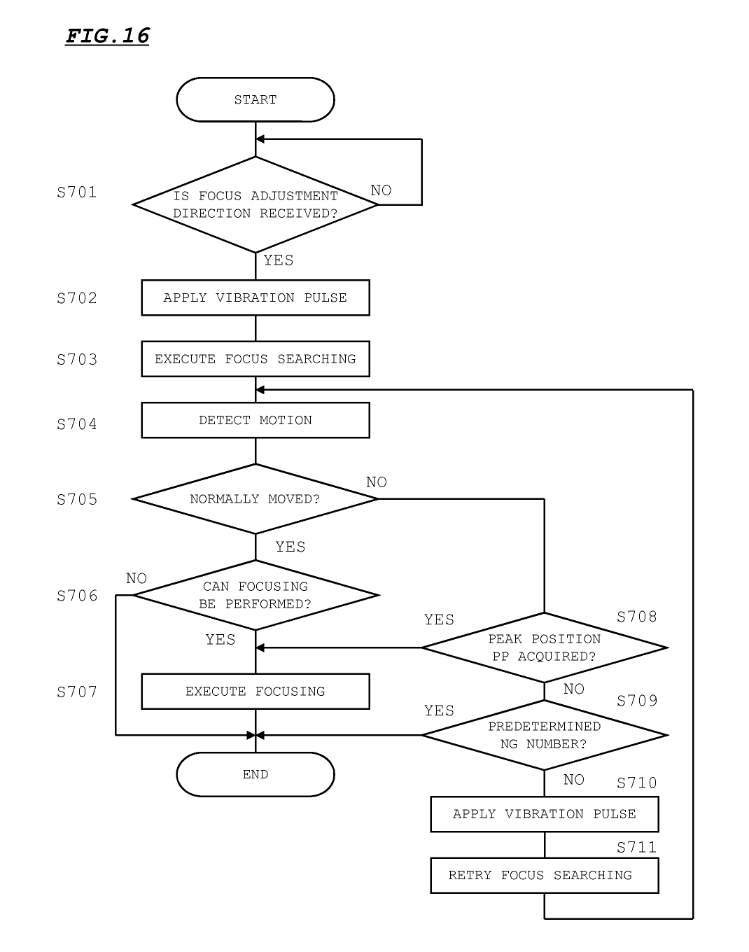

FIG. 16 is a flowchart for explaining an auto-focus operation according to the fourth modification.

Referring to FIG. 16, if the CPU 301 receives a direction to adjust focus (S701: YES), the CPU 301 applies a vibration pulse to the coil 40 (S702), and then, executes the focus searching processing (S703). Next, the CPU 301 detects motion of the lens holder 10 at the time of the focus searching (S704) and judges whether the lens holder 10 has normally moved (S705).

If the CPU 301 judges that the lens holder 10 has normally moved (S705: YES), the CPU 301 judges whether focusing can be performed (S706). If the focusing can be performed (S706:YES), the focusing processing is executed (S707).

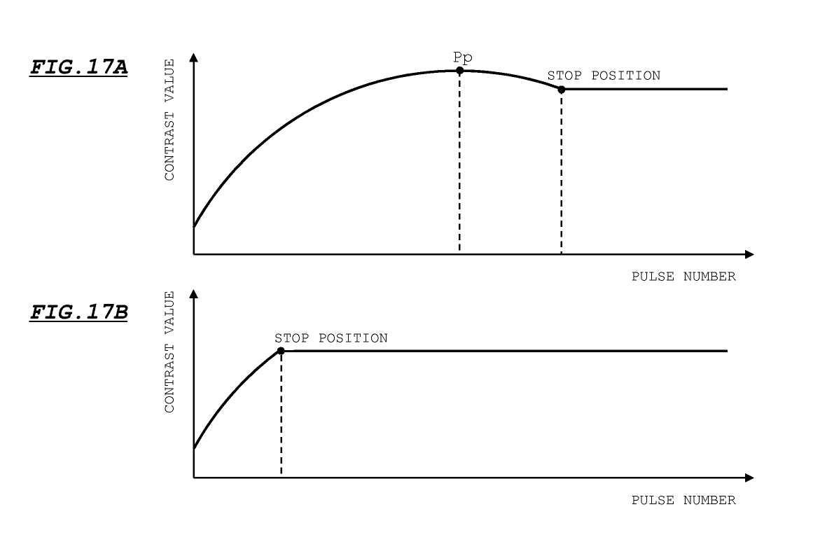

On the other hand, if the CPU 301 judges that the lens holder 10 does not normally move (S705: NO), the CPU 301 judges that a peak position Pp (focusing pulse number) of the contrast value has been detected by the focus searching (S708). If the peak position Pp has been detected as shown in FIG. 17A (S708: YES), the CPU 301 judges that focusing can be performed and executes the focusing processing (S707).

On the other hand, if the peak position Pp has not been detected as shown in FIG. 17B (S708: NO), the CPU 301 performs the same processings as those in S507 through S509 in FIG. 13 (S709 through S711).

In the configuration according to the fourth embodiment, even if the lens holder 10 stops in the middle at the time of the focus searching, focusing onto the on-focus position can be executed as much as possible.

### Fifth Modification of Auto-Focus Operation

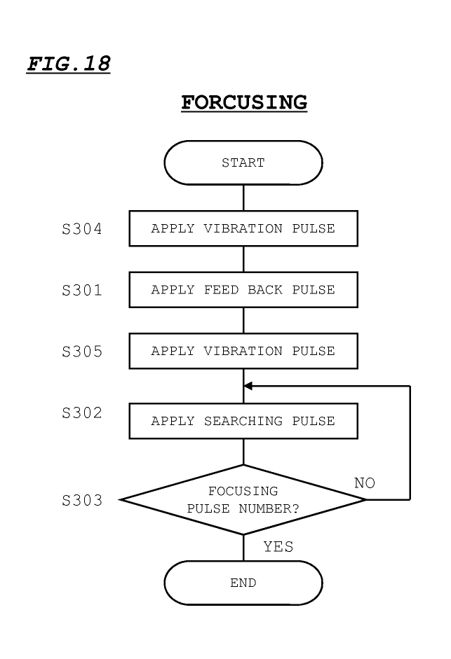

FIG. 18 is a flowchart of the focusing processing according to the fifth modification. As shown in FIG. 18, in the fifth modification, operations of applying a vibration pulse (S304, S305) are added before the application of the feed back pulse (S301) and the application of the searching pulse (S302), respectively, in the focusing processing according to the above embodiment. Other steps are the same as those of the focusing processing according to the above embodiment.

As reasons why the lens holder 10 is not easily moved other than firm fixing between the shafts 60, 61 and the circular hole 12 and the long hole 13, the following reason can be supposed. That is to say, slight clearances between the shafts 60, 61 and the circular hole 12 and the long hole 13 are set. Therefore, the lens holder 10 displaces and stops in a slightly inclined state in a range of the clearances in some case. In such a case, although the lens holder 10 can displace in the previous displacement direction, the lens holder 10 has a difficulty in displacing in the opposite direction in some case by being caught by the clearances. This arises a risk that the lens holder 10 does not move even if a current signal is applied.

In the configuration according to fifth modification, when the lens holder 10 is displaced in the opposite direction, that is, when the lens holder 10 is once fed back to the home position and the lens is focused onto the focusing position after the feedback, a vibration pulse is applied. Then, the lens holder 10 is driven in the feed back direction and the focusing direction. Therefore, when the lens holder 10 is driven in the opposite direction, even if the lens holder 10 is caught by the clearances as described above, the lens holder 10 is displaced after eliminating the catching. Therefore, the lens holder can be smoothly displaced.

Necessity of the configuration according to the fifth modification is small in the lens holder 10 having a supporting mechanism (see, FIG. 4A) by which an inclination of the lens holder 10 is suppressed by pressing the lens holder 10 against the shafts 60, 61 and the circular hole 12 and the long hole 13 with attractive forces of the magnets 20 and the magnetic plates 50. However, the configuration according to the fifth modification is particularly effective in a lens holder which does not have such configuration.

The above-described catching may be caused in the lens holder 10 in a state when the lens holder 10 is initially located at the home position. In such a case, the catching is eliminated by applying a vibration pulse before the focus searching processing is performed.

### Modification of Imaging Apparatus

In the above embodiment, the imaging apparatus does not have a function of directly detecting a position of the lens holder 10. However, a sensor for directly detecting a position of the lens holder 10 can be added to the imaging apparatus.

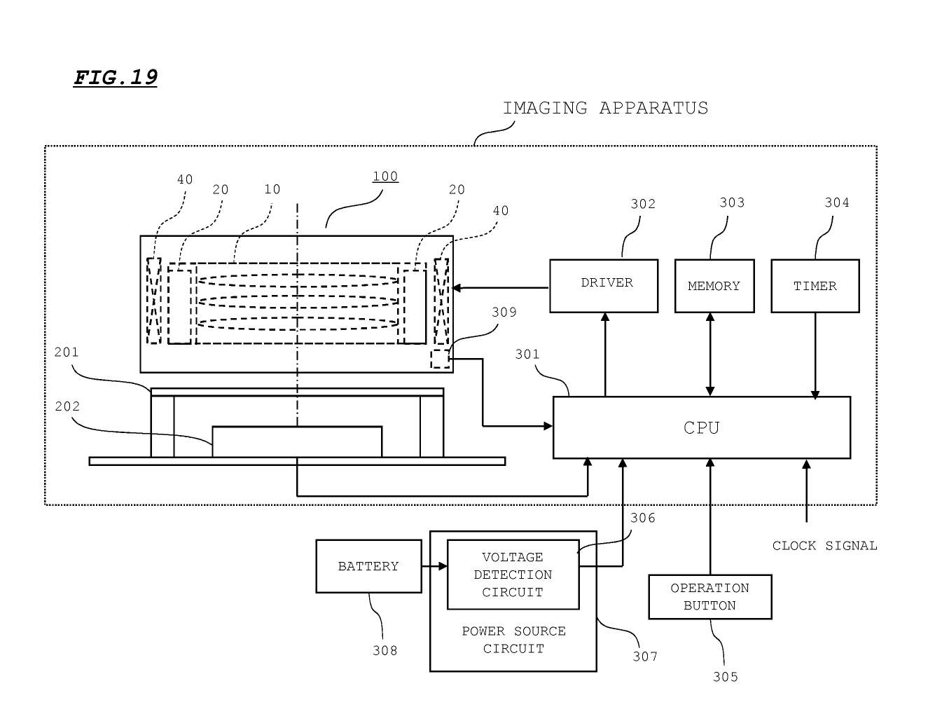

FIG. 19 is a view illustrating a schematic configuration of the imaging apparatus according to the modification. A hall element 309 is arranged as a positional sensor on the lens driving apparatus 100. If magnitude of the magnetic force received by the magnets 20 changes in accompanied with the displacement of the lens holder 10, the hall element 309 outputs a positional signal in accordance with the magnetic force to the CPU 301. The CPU 301 detects a position of the lens holder 10 based on the positional signal.

In the imaging apparatus according to the modification, the above auto-focus operation (including those according to the modifications) can be applied. In this case, whether the lens holder 10 is appropriately driven is detected based on the signal from the hall element 309. It is to be noted that the focus searching processing and the focusing processing are changed as follows.

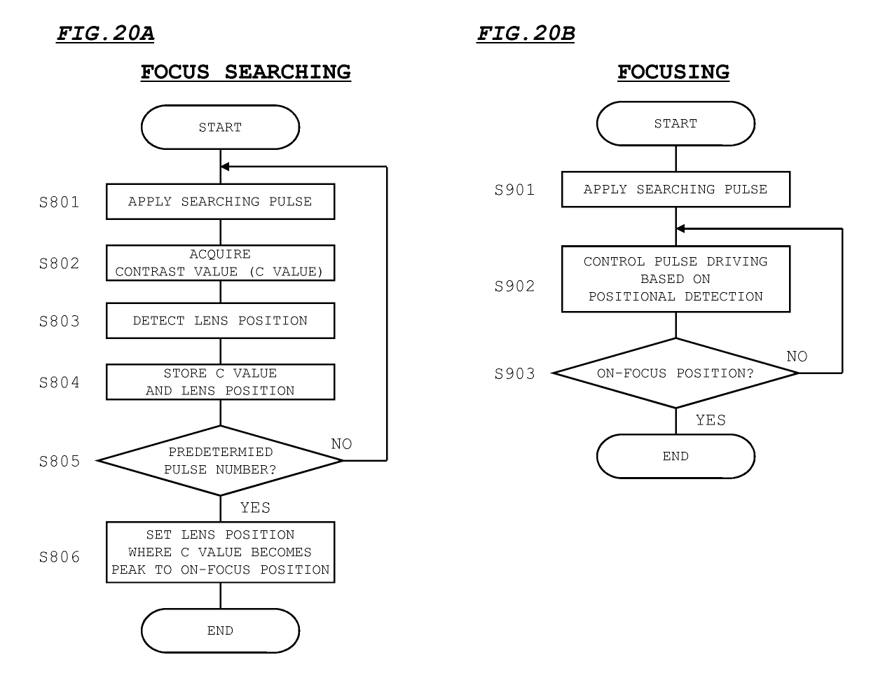

FIG. 20A is a flowchart for explaining a focus searching processing according to the modification. Referring to FIG. 20A, the CPU 301 applies a searching pulse to the coil 40 so as to displace the lens holder 10 (S801). Every time the searching pulse is applied, the CPU 301 acquires a contrast value from the image sensor unit 202 (S802) and detects a position of the lens holder 10 (lens position) based on the positional signal from the hall element 309 (S803). Then, the acquired contrast value is stored in the memory 303 in a state where the acquired contrast value is related to the lens position at that time (S804).

If the lens holder 10 is displaced to a terminal position of the focus adjustment region by applying the searching pulse the predetermine number of times (S805: YES), the CPU 301 acquires a lens position when the contrast value becomes a peak from the memory 303. Then, the CPU 301 sets the lens position as an on-focus position (S806).

FIG. 20B is a flowchart for explaining a focusing processing according to the modification. Referring to FIG. 20B, the CPU 301 applies a vibration pulse at first (S901). Next, pulse driving control is executed based on the positional detection by the hall element 309 in order to displace the lens holder 10 to the on-focus position from the terminal position (S902). That is to say, the CPU 301 adjusts a current signal based on a difference between the on-focus position and the present position so as to make the pulse width larger as the difference is larger. Then, the CPU 301 applies the adjusted current signal to the coil 40 so as to focus the lens holder 10 on the on-focus position. If the lens holder 10 is focused on the on-focus position (S903: YES), the process is terminated.

As described above, in the modification, whether the lens holder 10 is appropriately driven is detected based on the signal from the hall element 309. That is to say, the CPU 301 monitors the signal from the hall element 309 at the time of the focus searching. If the signal does not change from the start, or does not change from the middle, the CPU 301 judges that the lens holder 10 does not normally move.

### Modification of Lens Driving Apparatus

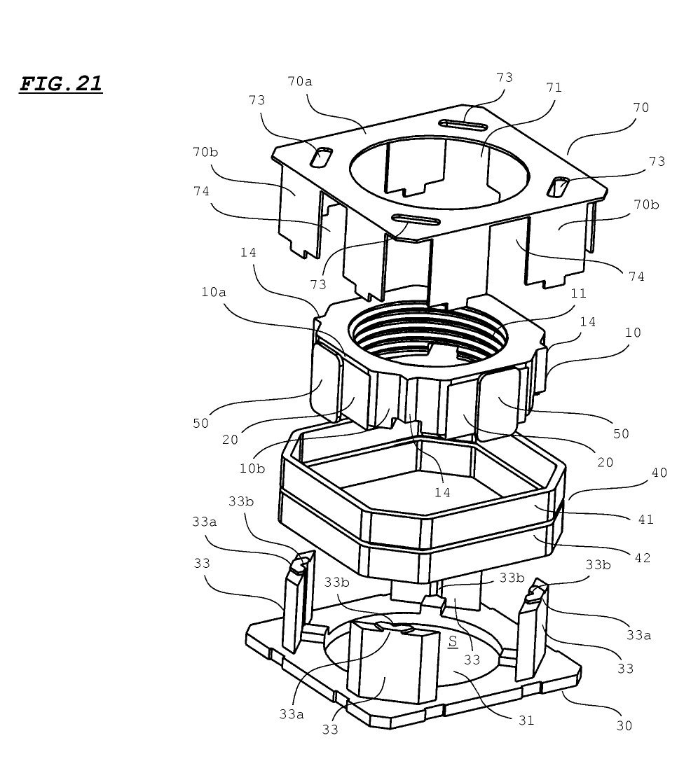

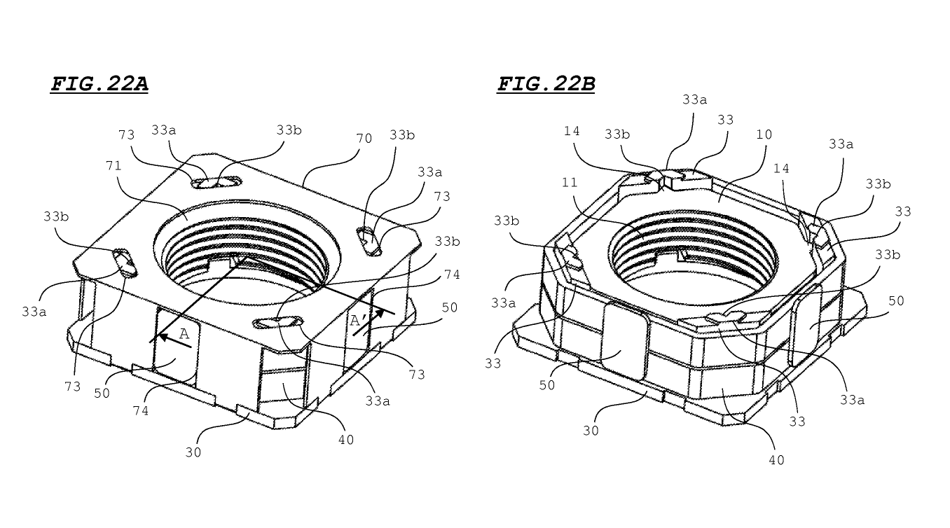

FIG. 21 is an exploded perspective view illustrating a lens driving apparatus according to the modification. FIGS. 22A and 22B are views illustrating a configuration of the lens driving apparatus after assembled. FIG. 22A is a view illustrating the lens driving apparatus completely assembled. FIG. 22B is a view illustrating a state where the cover 70 is removed from the lens driving apparatus as shown in FIG. 22A so as to see an internal state of the lens driving apparatus.

In the modification, a guiding configuration when the lens holder 10 is moved is not composed of the shafts 60, 61, the circular hole 12 and the long hole 13. As will be described below, the guiding configuration is composed of protrusions 14 and grooves 33b. Other components shown in FIG. 21, FIGS. 22A and 22B are the same as those in the above embodiment.

That is, each protrusion 14 having a triangular cross-sectional shape extending in the vertical direction is formed on each four side face 10b having small width, on the lens holder 10. On the other hand, V-shaped grooves 33b which engage with the protrusions 14 are formed on the respective side faces of the guiding member 33, which are opposed to these side faces 10b.

As shown in FIG. 22B, if the lens holder 10 is attached to the base 30, the protrusions 14 are fitted into the grooves 33b. If the lens holder 10 is moved in the vertical direction in this state, the protrusions 14 are slidingly moved in the grooves 33 in accompanied with the movement. With this configuration, the guiding configuration can be easily provided.

In the configuration according to the modification, the above auto-focus operation (including those according to the modifications) can be also applied.

### Application Example to Macro Switching Function

The imaging apparatus according to the invention can be applied to an imaging apparatus on which a lens driving apparatus for macro switching is mounted. In such lens driving apparatus for macro switching, a position of the lens is fixed so as to be switchable between two positions of a position when a normal photographing is performed (normal position) and a position when a macro photographing is performed (macro position).

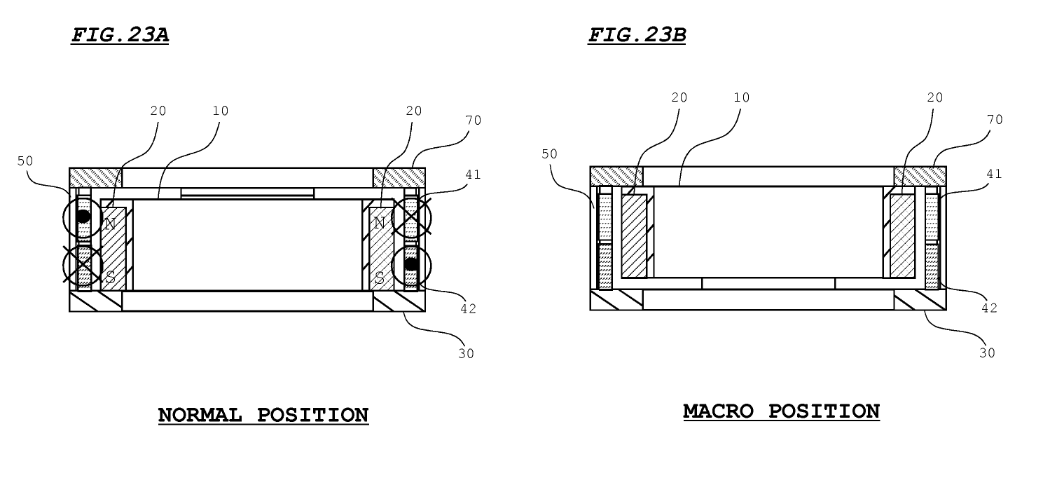

The lens driving apparatus for macro switching can have the same configuration as that in the lens driving apparatus 100 according to the above embodiment. In the case of the lens driving apparatus, as shown in FIGS. 23A and 23B, the home position (a position where the lens holder 10 abuts against the base 30) is positioned at the normal position and a position where the lens holder 10 abuts against the cover 70 is positioned at the macro position. The lens holder 10 is driven between the normal position and the macro position in accordance with switching operation of photographing modes (switching operation of lens positions) or the like by a user.

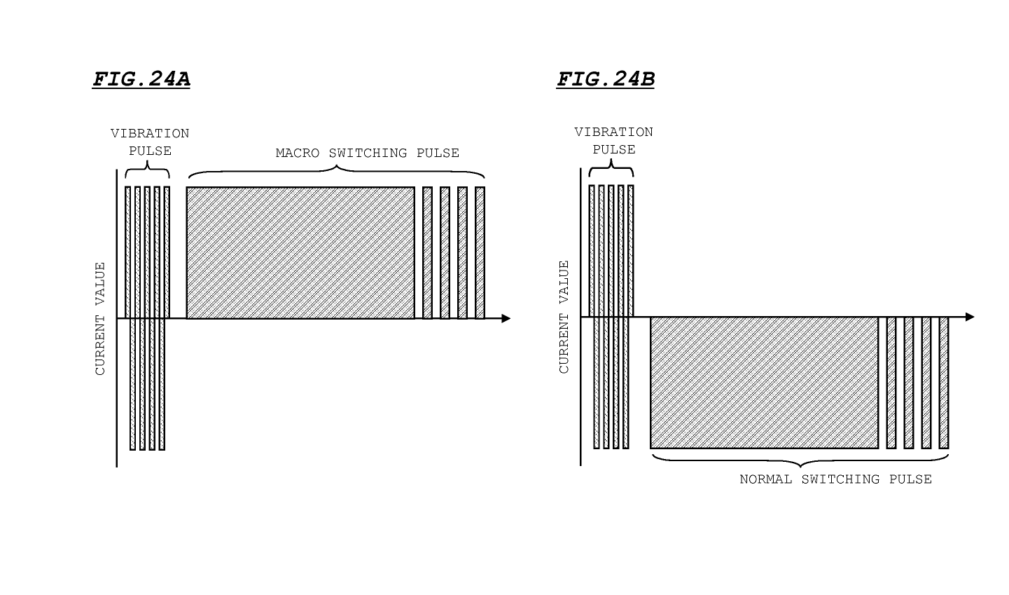

FIGS. 24A and 24B are diagrams illustrating a waveform of a current signal for displacing the lens holder 10 between the normal position and the macro position. FIG. 24A is a waveform diagram for displacing the lens holder 10 from the normal position to the macro position. FIG. 24B is a waveform diagram for displacing the lens holder 10 from the macro position to the normal position.

As shown in FIGS. 24A and 24B, both of a current signal for displacing the lens holder 10 to the macro position (hereinafter, referred to as “macro switching pulse”) and a current signal for displacing the lens holder 10 to the normal position (hereinafter, referred to as “normal switching pulse”) have the same waveform as the above feed back pulse. Both of the current signals include one current signal having long pulse width and a plurality of current signals having short pulse width. However, since directions for displacing the lens holder 10 are opposite to each other in the macro switching pulse and the normal switching pulse, the pulses have polarities inverted to each other. In the modification, as in the above case of applying the feed back pulse, when the lens holder 10 is positioned to the normal position or the macro position by applying such switching pulses, the lens holder 10 is prevented from being deviated.

Further, in the modification, as shown in FIGS. 24A and 24B, a vibration pulse is applied before applying the switching pulses. Therefore, as in the above embodiment, even when the firm fixing, catching, or the like is caused in the guiding mechanism portion, the firm fixing, catching, or the like can be eliminated by the vibration.

### Setting Example of Vibration Pulse

The imaging apparatus according to the embodiment is mounted on a camera, a mobile phone, or the like. In this case, an image imaged by the imaging apparatus is displayed on a preview screen on such a device. It is not desirable that change which is different from a direction from a user is caused on the image displayed on the preview screen (hereinafter, referred to as “preview image”). However, in the imaging apparatus according to the embodiment, the lens holder 10 vibrates in the optical axis direction by applying a vibration pulse. Therefore, change which is different from a direction (for example, auto-focus) from a user may be caused on the preview image by the vibration. Accordingly, in the embodiment, the vibration pulse is needed to be adjusted so as not to affect the preview screen when the lens holder 10 vibrates.

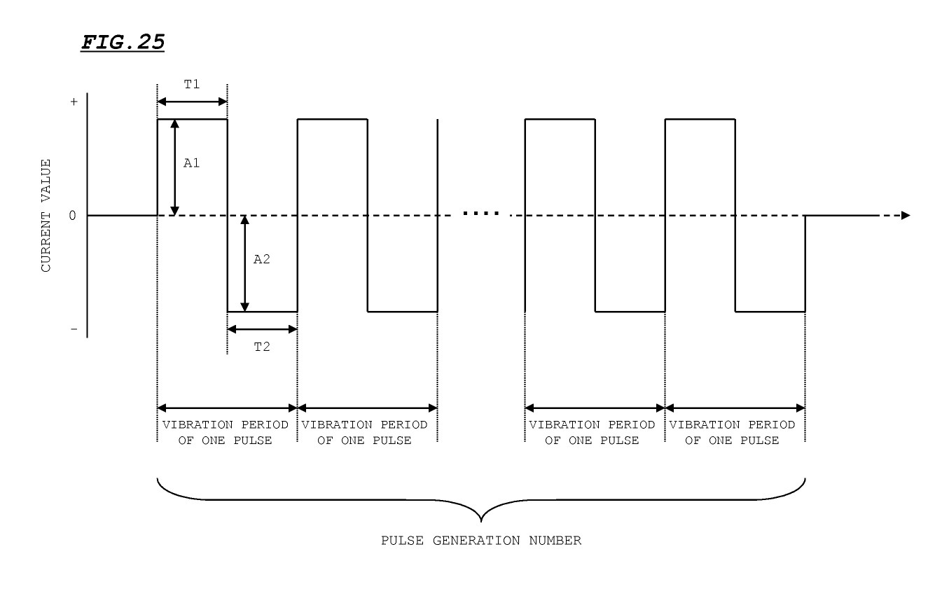

FIG. 25 is a diagram for explaining a method of adjusting the vibration pulse.

As shown in FIG. 25, positive vibration widths, positive pulse widths, negative vibration widths, and negative pulse widths of the vibration pulse are assumed to be A1, T1, A2, T2, respectively. Then, a duty ratio is set to 50% (A1=A2 and T1=T2). Further, the positive pulses and the negative pulses are generated by the same number of times and the number of times that pulses are generated is set to a predetermined number of times.

If the duty ratio of the vibration pulse is set to 50% and the positive pulses and the negative pulses are generated by the same number of times as described, the position of the lens holder 10 is not changed by application of the vibration pulse. Therefore, the preview image is not changed. Further, if the number of times that the pulses are generated is set to a minimum number of times to the degree that a failure of the lens operation is eliminated, the time and power consumption needed for applying the vibration pulse can be reduced.

Note that the positive pulse width T1 and the negative pulse width T2 are set to time width so as not to affect the preview image. That is to say, the positive pulse width T1 and the negative pulse width T2 are previously set in a range of time width with which the preview image is not affected in consideration of characteristics of the lens driving apparatus.

### Modification of Control at the time of Operation Failure

The lens holder 10 may not move appropriately even when the above vibration pulse is applied to the lens driving apparatus. In such a case, application of a vibration pulse having a pattern different from that at the time of stationary operation is effective in some case.

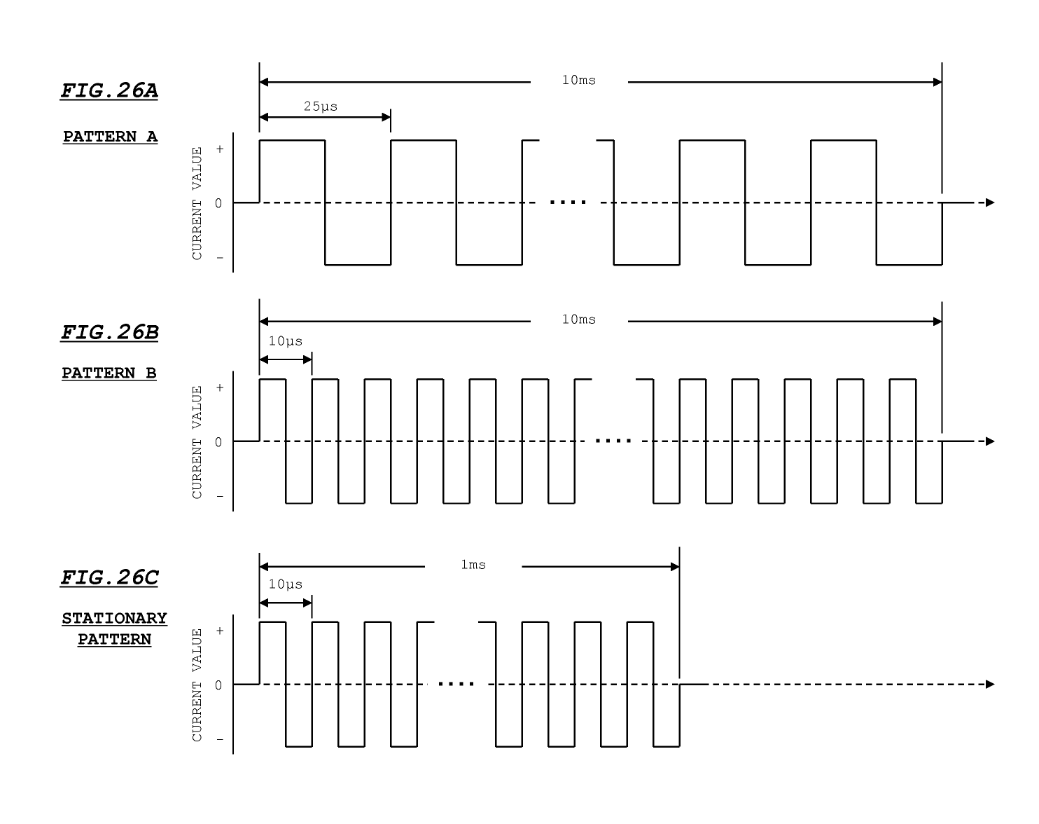

FIGS. 26A to 26C are diagrams illustrating a modification example of a vibration pulse when operation failure is caused in the lens driving apparatus.

FIG. 26C is a pattern example of a vibration pulse at the time of stationary operation (stationary pattern). In this case, a pulse having a period of 10 μs is applied to the lens driving apparatus for 1 ms. Further, FIGS. 26A and 26B are pattern examples of the vibration pulse different from that at the time of stationary operation (pattern A and pattern B).

In the pattern A as shown in FIG. 26A, a pulse having a period of 25 μs is applied to the lens driving apparatus for 10 ms. Further, in the pattern B as shown in FIG. 26B, a pulse having a period of 10 μs is applied to the lens driving apparatus for 10 ms. In any of the examples as shown in FIGS. 26A, 26B and 26C, a duty ratio is 50% and the positive pulses and the negative pulses are generated by the same number of times as described above with reference to FIG. 25.

In a case where the vibration pulse is applied to the lens driving apparatus, the stationary pattern is applied at first. Thereafter, whether the lens holder 10 normally moves (for example, whether the auto-focus is performed appropriately as described above) is judged. If it is judged that the lens holder 10 does not normally move and a vibration pulse is applied again, a pulse having the pattern A is applied as the vibration pulse. If it is further judged that the lens holder 10 does not normally move and a vibration pulse is applied again, a pulse having the pattern B is applied as the vibration pulse. Subsequently, the pulse having the pattern A and that having the pattern B are repeatedly applied alternately by a predetermined number of times.

With this operations, vibration pulses having different patterns are alternately applied unlikely the case where only the pulse having the stationary pattern is applied. Therefore, movement failure of the lens driving apparatus can be eliminated more effectively.

Further, a configuration in which time of the pulse vibration can be arbitrarily changed by a user may be employed. To be more specific, a configuration in which a user can select a multiplying factor with respect to the vibration time of the above patterns A and B from a menu screen or the like of the imaging apparatus may be employed. With this configuration, when the operation failure of the lens driving apparatus is not eliminated, the user can make the time of the pulse vibration longer. Therefore, a possibility that the operation failure of the lens driving apparatus is quickly eliminated can be increased.

For example, if a user performs a selection operation of doubling the vibration time on the menu screen, each of the application time of the pulse having the pattern A as shown in FIG. 26A and that of the pulse having the pattern B as shown in FIG. 26B is set to 20 ms. Then, the vibration pulse having the pattern A is applied to the lens driving apparatus for 20 ms. Thereafter, it is judged whether the lens holder 10 normally moves. If the lens holder 10 does not normally move, the vibration pulse having the pattern B is applied to the lens driving apparatus for 20 ms. In such a manner, the vibration pulse having the pattern A and that having the pattern B of which application times are extended to 20 ms are alternately applied to the lens driving apparatus by a predetermined number of times.

Similarly, if a user performs a selection operation of making the vibration time three times, four times, five times, or the like on the menu screen, each of the application time of the pulse having the pattern A as shown in FIG. 26A and that of the pattern B as shown in FIG. 26B is set to 30 ms, 40 ms, 50 ms, or the like. In such a manner, the vibration pulse having the pattern A and that having the pattern B of which application times are extended are alternately applied to the lens driving apparatus.

It is to be noted that a configuration in which a user can select the number of times that the pulse having the pattern A and the pulse having the pattern B are repeatedly applied in addition to the multiplying factor with respect to the vibration times of the pattern A and the pattern B may be employed. Further, a configuration in which the user can select any one of the pattern A and the pattern B and selectively set the vibration time (multiplying factor) of the selected pattern may be employed.

In addition, not a configuration in which the pulse having the pattern A and the pulse having the pattern B are repeatedly applied as described above but a configuration in which any one of the pulse having the pattern A and the pulse having the pattern B is applied once or is repeatedly applied a predetermined number of times may be employed. In this case, a configuration in which the application time of a pulse having the selected pattern can be set with a multiplying factor, for example, on the menu screen as in the above manner may be employed.

Note that although the vibration pulse having the pattern A and the vibration pulse having the pattern B are repeatedly applied in this order as vibration pulses at the time of the operation failure, the vibration pulse having the pattern B and the vibration pulse having the pattern A may be applied in this order. The vibration pulse having the pattern A and the vibration pulse having the pattern B are alternately applied because the patterns which can eliminate the operation failure may be different depending on the reasons of the operation failure. From the viewpoint, when the pulse having the pattern B is the same as that having the stationary pattern as shown in FIGS. 26B and 26C, it can be considered to be effective that the pulse having the pattern A which has a different pulse width from that of the pulse having the stationary pattern is applied first. When the pulse width of the pulse having the pattern B is different from that of the pulse having the stationary pattern, the pulse having the pattern B may be applied before the application of the pulse having the pattern A. As described above with reference to FIG. 25, the pulse widths of the pulses having the pattern A and the pattern B are needed to be set to time widths which does not affect the preview screen.

The pulse patterns of the vibration pulses applied at the time of operation failure are not limited to those as shown in FIGS. 26A, 26B and 26C. In FIGS. 26A, 26B and 26C, two patterns other than the stationary pattern are shown. However, a pulse having one pattern which is different from the stationary pattern may be applied or three or more pulses having different patterns may be repeatedly applied at the time of operation failure.

In addition, the embodiment of the invention can be variously modified as appropriate in a range of a technical scope as described in the Claims.

What is claimed is:

1. An imaging apparatus comprising:
a lens actuator which displaces a lens so as to slidingly move along a guide member; and
a control circuit which controls the lens actuator,
wherein the control circuit supplies a driving signal for vibrating the lens in a first direction and a second direction opposite to the first direction to the lens actuator before the lens is displaced in the first direction along the guide member.

2. The imaging apparatus according to claim 1,
wherein the control circuit performs optical adjustment control by using the lens, and
the control circuit supplies a driving signal for vibrating the lens to the lens actuator before the optical adjustment control is started.

3. The imaging apparatus according to claim 2,
wherein when the optical adjustment is not appropriate, the control circuit supplies a driving signal for vibrating the lens to the lens actuator again, and a pattern of the driving signal supplied to the lens actuator when the optical adjustment is not appropriate is different from a pattern of the driving signal supplied to the lens actuator before the optical adjustment control is started.

4. The imaging apparatus according to claim 1,
wherein the control circuit performs optical adjustment control by using the lens, and
the control circuit judges whether the optical adjustment is appropriate, and when the optical adjustment is not appropriate, after a driving signal for vibrating the lens is supplied to the lens actuator, the optical adjustment control is performed again.

5. The imaging apparatus according to claim 4,
wherein the control circuit monitors whether the lens is displaced appropriately at the time of the optical adjustment control, and when it is judged by the monitoring that the lens is not displaced appropriately, after a driving signal for vibrating the lens is supplied to the lens actuator, the optical adjustment control is performed again.

6. The imaging apparatus according to claim 1, further comprising a timer which measures time,
wherein after a predetermined period of time has passed since the lens displacement operation has been performed, the control circuit supplies a driving signal for vibrating the lens to the lens actuator when the lens is newly displaced.

7. imaging apparatus according to claim 1, further comprising a battery detection circuit which detects a state of a battery,
wherein the control circuit supplies a driving signal for vibrating the lens to the lens actuator when the lens is newly displaced after the battery detection circuit detects a charging operation to the battery or an exchange of the battery.

8. The imaging apparatus according to claim 1,
wherein the control circuit sets a pattern of the driving signal supplied to the lens actuator in accordance with input from a user.
